(19) United States
(12) Patent Application Publication
(10) Pub. No.: US 2015/0347694 A1
(43) Pub. Date: Dec. 3, 2015

(54) METHOD AND SYSTEM FOR SELECTING READERS FOR THE ANALYSIS OF RADIOLOGY ORDERS USING ORDER SUBSPECIALTIES

(71) Applicant: INTELERAD MEDICAL SYSTEMS INCORPORATED, MONTREAL (CA)

(72) Inventors: Desmond Ryan Chung, Thornhill (CA); Elizabeth Lam, Toronto (CA)

(21) Appl. No.: 14/713,629

(22) Filed: May 15, 2015

Related U.S. Application Data
(60) Provisional application No. 62/005,227, filed on May 30, 2014.

(51) Int. Cl. G06F 19/00

(52) U.S. Cl. CPC G06F 19/327; G06F 19/321

(57) ABSTRACT

There is described a computer-implemented method for selecting readers to analyze a medical image, comprising use of at least one processing unit for: receiving a radiology order associated with the medical image; determining an order subspecialty corresponding to the radiology order; comparing a reader subspecialty of each one of a group of readers to the determined order subspecialty of the radiology order; identifying given readers amongst the group of readers who are qualified for analyzing the radiology order using the comparison; and outputting an identification of the given readers.

### CROSS-REFERENCE TO RELATED APPLICATIONS

This application claims priority of U.S. Provisional Patent Application having Ser. No. 62/005,227, which was filed on May 30, 2014 and is entitled “Method and system for assignment of radiology orders readers”, the specification of which is hereby incorporated by reference.

### TECHNICAL FIELD

The present invention relates to the field of methods and systems for assigning medical images to readers such as radiologists, and more particularly to methods and systems for selecting readers to analyze radiology orders according to order subspecialties.

### BACKGROUND

In the field of medical images, once it has been generated, a medical image has to be analyzed by a radiologist who has to establish a diagnosis. A radiology order corresponding to the generated medical image is then created and uploaded to a picture archiving and communication system (PACS) such as a digital imaging and communications in medicine (DICOM) system. The DICOM system is adapted to store the radiology orders and provide radiologists with an access to the stored radiology orders.

In some instances, the newly generated medical images are regrouped in a pool of images in the DICOM system and the radiologists choose the radiology orders that they wish to analyze from the pool. In such a method of radiology order allocation, some radiologists may wrongly prioritize important radiology orders or they may prioritize radiology orders that are easier to analyze instead of radiology orders to be read urgently. Furthermore, such a method does not ensure that the radiology order will be analyzed by one of the most qualified readers.

In other instances, a team of people referred to as “air traffic Controllers” (ATCs) are in charge of deciding which radiologist should analyze a given radiology order and manually assign it to the chosen radiologist. However, such a method requires the ATCs to monitor the traffic (i.e. the radiology orders that are unassigned and the radiology orders that are assigned) in addition to monitor the radiologists' queues of radiology orders, which is time-consuming.

Therefore, there is a need for an improved method and system of selecting readers to analyze a given radiology order.

### SUMMARY

According to a first broad aspect, there is provided a computer-implemented method for selecting readers to analyze a medical image, comprising use of at least one processing unit for: receiving a radiology order associated with the medical image; determining an order subspecialty corresponding to the radiology order; comparing a reader subspecialty of each one of a group of readers to the determined order subspecialty of the radiology order; identifying given readers amongst the group of readers who are qualified for analyzing the radiology order using the comparison; and outputting an identification of the given readers.

In one embodiment, the step of determining an order subspecialty comprises parsing the radiology order using a predefined set of parsing rules.

In one embodiment, at least one of the parsing rules assigns a given subspecialty to a given modality.

In another embodiment, at least one of the parsing rules assigns a given subspecialty to at least one keyword.

In a further embodiment, at least one of the parsing rules assigns a given subspecialty to a given period of time.

In one embodiment, the step of determining an order subspecialty comprises extracting at least one procedure code from the radiology order and retrieving the order subspecialty from a database using the extracted procedure code.

In one embodiment, the step of determining an order subspecialty comprises determining at least one required subspecialty for the radiology order, and the step of comparing a reader subspecialty comprises retrieving from a database a qualification subspecialty for each reader and comparing the qualification subspecialty of each reader to the required subspecialty of the radiology order.

In one embodiment, the step of identifying comprises identifying a given reader as being qualified for the radiology order when the qualification subspecialty of the given reader substantially corresponds to the required subspecialty of the radiology order.

In one embodiment, the method further comprises use of the at least one processing unit for determining a score for each reader as a function of the comparison, thereby ranking the readers, and the step of outputting further comprising outputting the score for each reader.

In one embodiment, the step of said determining an order subspecialty further comprises determining a preferred subspecialty for the radiology order, and the step of comparing a reader subspecialty further comprises retrieving from the database a preference subspecialty for each reader and comparing the preference subspecialty of each reader to the required and preferred subspecialties of the radiology order.

In one embodiment, the method further comprises use of the at least one processing unit for determining a score for each reader as a function of the comparison using weighting factors assigned to the qualification subspecialty and the preference subspecialty, thereby ranking the readers, and the step of outputting further comprising outputting the score for each reader.

In one embodiment, the step of determining an order subspecialty comprises determining at least two order subspecialties for the radiology order, the at least two order subspecialties being ranked according in a hierarchical configuration.

In one embodiment, the step of identifying given readers amongst the group of readers comprises identifying at least one given reader as being qualified for the radiology order when the reader subspecialty of the at least one given reader corresponds to a given one of the at least two order subspecialties having the highest rank according to the hierarchical configuration.

According to a second broad aspect, there is provided a computer program product for selecting readers to analyze a medical image, the computer program product comprising a computer readable memory storing computer executable instructions thereon that when executed by a processing unit perform the steps of the above-described method.

According to another broad aspect, there is provided a system for selecting readers as a function of their qualification to read a medical image, the system comprising: a subspecialty determining unit for receiving a radiology order associated with the medical image and determining a subspecialty corresponding to the radiology order; a comparison unit for comparing a subspecialty of each one of the readers to the determined subspecialty of the radiology order; and an identification unit for identifying given readers who are qualified for analyzing the radiology order using the comparison, and outputting an identification of the given readers.

In one embodiment, the subspecialty determining unit is adapted to parse the radiology order using a predefined set of parsing rules.

In one embodiment, at least one of the parsing rules assigns a given subspecialty to a given modality.

In one embodiment, at least one of the parsing rules assigns a given subspecialty to at least one keyword.

In one embodiment, at least one of the parsing rules assigns a given subspecialty to a given period of time.

In one embodiment, the subspecialty determining unit is adapted to extract at least one procedure code from the radiology order and retrieve the order subspecialty from a database using the extracted procedure code.

In one embodiment, the subspecialty determining unit is adapted to determine at least one required subspecialty for the radiology order, and the comparison unit is adapted to retrieve from a database a qualification subspecialty for each reader and compare the qualification subspecialty of each reader to the required subspecialty of the radiology order.

In one embodiment, the identification unit is adapted to identify a given reader as being qualified for the radiology order when the qualification subspecialty of the given reader substantially corresponds to the required subspecialty of the radiology order.

In one embodiment, the system further comprises a ranking unit for determining a score for each reader as a function of the comparison, thereby ranking the readers, and outputting the score for each reader.

In one embodiment, the subspecialty determining unit is adapted to determine a preferred subspecialty for the radiology order, and the comparison unit is adapted to retrieve from the database a preference subspecialty for each reader and comparing the preference subspecialty of each reader to the required and preferred subspecialties of the radiology order.

In one embodiment, the subspecialty determining unit is adapted to determine at least two order subspecialties for the radiology order, the at least two order subspecialties being ranked in a hierarchical configuration.

In one embodiment, the identification unit is adapted to identify at least one given reader as being qualified for the radiology order when the reader subspecialty of the at least one given reader corresponds to a given one of the at least two order subspecialties having the highest rank according to the hierarchical configuration.

For a radiology order, a required subspecialty refers to a subspecialty qualification that a reader must possess in order for that reader to be considered as an acceptable reader to read the order. Examples include very specific neuroradiology orders that non-neuroradiology readers are not capable of reading, or pediatric cases that legally require interpretation by a reader with pediatric subspecialization.

A preferred subspecialty refers to a subspecialty qualification (or preference, where applicable) that a reader should possess in order to be assigned a high preference score for this order.

For a reader, a qualification subspecialty refers to the formal subspecialty certification that the reader has attained through study and/or exams. A qualification subspecialty may also refer to a subspecialty that is assigned to a reader for a given period of time such as for a work shift, one week, or the like. A preference subspecialty refers to a subspecialty type that a reader has marked as ‘desirable’, either due to personal preference or due to a site's policy.

### BRIEF DESCRIPTION OF THE DRAWINGS

Further features and advantages of the present invention will become apparent from the following detailed description, taken in combination with the appended drawings, in which:

FIG. 1 is a flow chart illustrating a method of determining readers who are qualified to analyze a radiology order, in accordance with an embodiment;

FIG. 2 illustrate a set of rules for determining the subspecialty of a radiology order, in accordance with an embodiment;

FIG. 3 is a block diagram illustrating a system for determining readers who are qualified to analyze a radiology order, in accordance with an embodiment;

FIG. 4 is a flow chart illustrating a method for determining the availability of a reader, in accordance with an embodiment;

FIG. 5 is a flow chart illustrating a method for determining readers adequate for analyzing a new order by its due-in-time requirement, in accordance with an embodiment; and

FIG. 6 is a block diagram illustrating a system for determining readers adequate for analyzing a new order by its due-in-time requirement, in accordance with an embodiment.

It will be noted that throughout the appended drawings, like features are identified by like reference numerals.

### DETAILED DESCRIPTION

Usually a radiology technician or radiologic technologist takes a medical image of at least of one body part of a patient and fulfills a radiology order. The radiology order is a form containing information about the medical image and information about the patient. The information about the medical image may comprise an identification of the imaging method/technology used for generating the medical image, referred hereinafter as the medical image modality, an identification of the body part that has been imaged, a due-in-time requirement for analyzing the medical image, i.e. the deadline for completing the analysis of the medical image, a study description which usually comprises a short description of the procedure used to capture the medical image(s), comments from the technician, a priority status for the analysis of the radiology order such as low priority, normal priority, critical priority, or stat or statim priority, and/or the like. The patient information may comprise information such as the gender of the patient, the age of the patient, the name of the patient, an identification (ID) number or code associated with the patient, and/or the like.

In one embodiment, the radiology order may further comprise an identification of at least one subspecialty associated with the medical image. For example, the subspecialty may be written in the radiology order. In another example, the subspecialty may be encoded in the form of a code which is written in the radiology order. While the present description refers to a single subspecialty associated with a radiology order, it should be understood that more than one subspecialty may be associated with a same radiology order.

In the same or another embodiment, the radiology order may further comprise the medical image itself. While the present description refers to a single medical image associated with a radiology order, it should be understood that more than one medical image may be associated with a same radiology order.

In one embodiment, the radiology order is a paper form which is manually fulfilled and subsequently scanned to be converted into a digital or electronic format. In another embodiment, the radiology order is an electronic form which is fulfilled using a computer. The scanned order or the electronic order is then stored in memory.

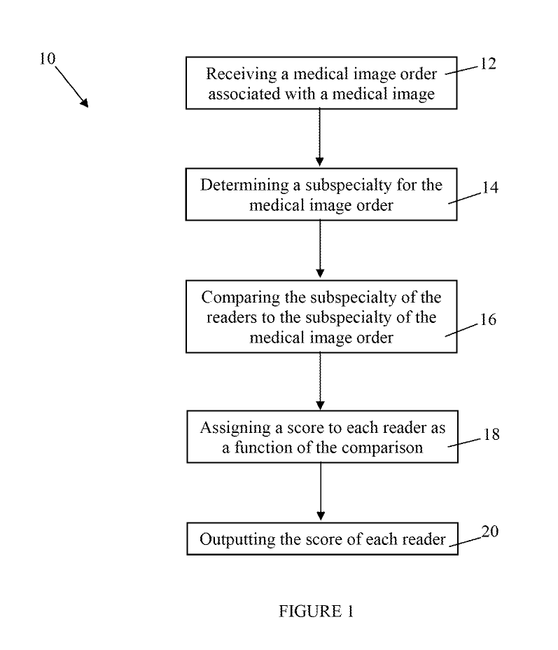

FIG. 1 illustrates one embodiment of a computer-implemented method 10 for ranking readers according to their subspecialty relative to the subspecialty associated with a medical image order or radiology order. It should be understood that the method 10 is implemented by a computer machine provided with at least a processing unit, a memory, and communication means for receiving and/or transmitting data. Statements and/or instructions are stored on the memory so that, when executed by the processing unit, the steps of the method 10 are performed by the processing unit.

At step 12, the processing unit is used to receive a radiology order. As described above, the radiology order comprises information about a medical image and information about the patient.

At step 14, the subspecialty associated with the radiology order is determined. In an embodiment in which the subspecialty of the radiology order is explicitly contained in the radiology order, the step 14 comprises extracting the subspecialty from the radiology order. When the radiology order is encoded, the code associated with the subspecialty is extracted and the corresponding subspecialty is retrieved from a database containing subspecialty codes and at least one respective subspecialty for each subspecialty code. For example, the code associated with a subspecialty may be an order procedure code which is mapped to a respective subspecialty in a database. When the radiology order is a scan of a paper form, optical character recognition (OCR) may be used for extracting the subspecialty or the code from the radiology order.

In an embodiment in which the subspecialty is not explicitly contained in the radiology order, the step 14 comprises determining the subspecialty from the information about the medical image and/or the information about the patient contained in the radiology order. Information relevant to the determination of the radiology order may be retrieved from metadata fields of the radiology order, and the relevant information may be parsed using a set of rules in order to determine the subspecialty associated with the radiology order. It should be understood that the set of rules may be contained in a database stored in the memory.

In one embodiment, the set of rules may comprise fixed rules, text parsing rules, time-of-day rules, and/or the like. For example, a fixed rule may apply to the modality associated with the radiology order. In this case, the database comprises a list of modalities and at least one corresponding subspecialty for each modality contained in the list. For example, an order of which the modality corresponds to computed radiography (CR) or diagnostic radiology (DX) is assigned the “general radiology” subspecialty. In another example, a fixed rule may apply to the age of the patient. In this case, the database may comprise at least one range of ages and at least one corresponding subspecialty for each range of ages. For example, an order for a patient being less than 18 years old may be assigned the “pediatric radiology” subspecialty. In a further example, a fixed rule may apply to the priority status of a radiology order. In this case, the database may comprise a list of priority statuses and at least one corresponding subspecialty for each priority status. For example, a radiology order having a high priority such as a critical priority or a stat priority may be assigned the general radiology subspecialty. A text parsing rule applies to the text that is parsed from the radiology order. In an exemplary parsing rule, reference keywords detected from the parsed text may be associated, alone or in combination, with a given subspecialty. In this case, the database may comprise reference keywords or associations of reference keywords, and at least one corresponding subspecialty for each reference keyword or association of reference keywords. For example, when the radiology order comprises a description and the description comprises the association of reference keywords “brachial plexus”, then the subspecialty “neuroradiology” is assigned to the radiology order. In another example, if the parsing of the text contained in the radiology order allows for the determination of the age of the patient and the patient is less than 18 years old, then the “pediatric radiology” subspecialty is assigned to the radiology order. A time of day rule is a rule that only applies during a specific period of a day. In this case, the database may comprise at least one period of time such as a period of a day, and at least one corresponding subspecialty for each period of time. The following presents an exemplary time of day rule: overnight, emergency orders that would normally be associated with the musculoskeletal radiology subspecialty, may instead be associated with the general radiology subspecialty since such musculoskeletal radiology orders can be safely read by a wider class of readers.

In another embodiment in which the radiology order comprises a procedure code, the subspecialty associated with the radiology order may be determined using the procedure code. A procedure code is indicative of the procedure used to generate the medical image corresponding to the radiology order. For example, a given procedure code may be indicative of the following procedure: CT head scan with contrast. It should be understood that more than one procedure code may be contained in a radiology order and associated with the medical image corresponding to the radiology order.

In this case, a database comprises procedure codes and at least one corresponding subspecialty for each procedure code. For example, a single subspecialty may be assigned to a given procedure code in the database. In another example, at least a required subspecialty and a preferred subspecialty may be associated with a given procedure code.

The subspecialty associated with the radiology order is then determined by extracting the procedure code(s) contained in the radiology order and retrieving the subspecialty(ies) that correspond(s) to the extracted procedure code(s) from the database.

In an embodiment in which no radiology subspecialty is detected for a given radiology order, the general radiology subspecialty is assigned to the given radiology order. In this case, no specific subspecialty is required for a radiologist in order to read the given radiology order.

In an embodiment in which more than one radiology subspecialty is assigned to a radiology order, the assigned radiology subspecialties may be ranked by order of preference using ranking rules stored on the memory. In this case, a reader having at least one of the subspecialties assigned to the radiology order may be considered as an acceptable reader. However, a reader having a higher preference order subspecialty will be preferred over a reader having a lower preference order subspecialty. For example, if the “neuroradiology” and “body radiology” subspecialties are assigned to a radiology order, the “neuroradiology” subspecialty may be preferred over the “body radiology” subspecialty so that a reader having the “neuroradiology” subspecialty will be preferred over a reader having the “body radiology” subspecialty. However, if no reader having the “neuroradiology” subspecialty is available to analyze the medical image, then a reader having the “body radiology” subspecialty will be acceptable for analyzing the medical image.

In the same or another embodiment, the assigned radiology subspecialties may be ranked in a hierarchical configuration. In this case, a reader who does not have the highest hierarchical configuration subspecialty is not considered as an acceptable reader. For example, if a radiology order is assigned the “pediatric radiology” and “neuroradiology” subspecialties with the “pediatric radiology” subspecialty ranked first and the “neuroradiology” subspecialty ranked second, then a reader having these two radiology subspecialties is suited. In this case, the highest hierarchical level, i.e. the “pediatric radiology” subspecialty, must be met by a reader in order to be considered as an acceptable reader. If he does not have the “pediatric radiology” subspecialty, then the reader cannot read the radiology order. If they each have the “pediatric radiology” subspecialty, a first and a second readers are each considered as acceptable readers for the radiology order. If the first reader further has the “neuroradiology” subspecialty and the second reader does not have the “neuroradiology” subspecialty, then the first reader will be preferred over the second reader. It should be understood that the hierarchical configuration between the radiology subspecialties may be stored in a database.

In a further embodiment, the radiology subspecialties assigned to a radiology order each have an even importance so that a reader having at least one of the radiology subspecialties assigned to a radiology order is considered as an acceptable reader. In this case, there is no preference order or hierarchical configuration for the order subspecialties.

In still another embodiment, all of the radiology subspecialties assigned to a radiology order are mandatory for reviewing the medical image. In this case, a reader must have all of the radiology subspecialties assigned to a radiology order in order to be considered as an acceptable reader for analyzing the corresponding medical image.

It should be understood that any combination of the above-described ranking methods for the order radiology subspecialties may be used. For example, a hierarchy order may be assigned to some radiology subspecialties assigned to the radiology order while a preference order may be assigned to other radiology subspecialties assigned to the radiology order.

In an embodiment in which more than one radiology subspecialties are assigned to a radiology order, at least one radiology subspecialty may be considered as “required” while at least another one may be considered as “preferred”. In one embodiment, the qualification of a radiology order, i.e. whether a radiology order is required or preferred, may be determined based on global policy, where some organizations consider subspecialty matching mandatory or optional. It should be understood that the rules representing the global policy may be stored in a database and the qualification of a radiology order is determined by accessing the rules stored in the database. In another embodiment, the qualification of a radiology order may be determined on a per subspecialty basis, In this case, a database contains a qualification for each radiology subspecialty. For example, the database may indicate that a neuroradiology or pediatric subspecialty is required, i.e. only a reader having the neuroradiology or pediatric subspecialty, respectively, may analyze the radiology order. In the same or another example, the database may indicate that a musculoskeletal is preferred so that any reader may analyze the radiology order.

In order to be considered as an adequate reader, a reader must have any required radiology subspecialty as a qualification. A preferred radiology subspecialty improves the suitability of the radiology order to a reader with matching subspecialty qualification or preference. In one embodiment, the required subspecialties and/or the preferred subspecialties may be hierarchically organized.

In one embodiment, the order's subspecialties are considered constant for the duration of each instance of the order's suitability assessment. However, for subsequent assessments of radiology orders, the subspecialties may be modified, e.g. based on time of day properties. In another embodiment, the order subspecialties may vary during the duration of each instance of the order suitability assessment.

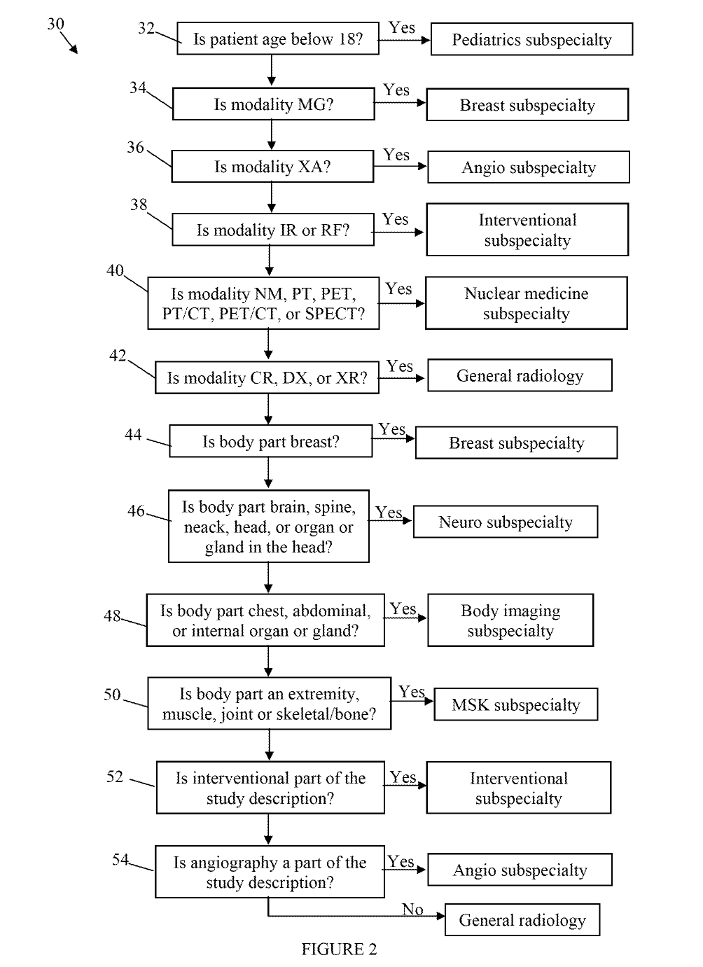

FIG. 2 illustrates one exemplary set of rules for determining the radiology subspecialty(ies) associated with a radiology order in which the associated subspecialty(ies) are not explicitly contained, and thus have to be extracted therefrom using the above-described method. Information such as the modality, the age of the patient, and/or the imaged body part, and/or information contained in the description of the radiology order are extracted from the radiology order. The set of rules are implemented as a flow chart 30 as illustrated in FIG. 2. At step 32, if it is determined that the age of the patient is under 18 years old, then the radiology pediatrics subspecialty is assigned to the radiology order. At step 34, if it is determined that the modality corresponding to the radiology order is mammography, then the radiology breast subspecialty is assigned to the radiology order. At step 36, if it is determined that the modality corresponding to the radiology order is X-ray angiography, then the radiology angiography subspecialty is assigned to the radiology order. At step 38, if it is determined that the modality corresponding to the radiology order is radio fluoroscopy or interventional radiology, then the radiology interventional subspecialty is assigned to the radiology order. At step 40, if it is determined that the modality corresponding to the radiology order is one of nuclear medicine, positron emission tomography, positron emission tomography—computed tomography, and single-photon emission computed tomography, then the radiology nuclear medicine subspecialty is assigned to the radiology order. At step 44, if it is determined from the radiology order that the imaged body part is a breast, then the radiology breast subspecialty is assigned to the radiology order. At step 46, if it is determined from the radiology order that the imaged body part is the brain, the spine, the neck, the head, or an organ or gland present in the patient head such as an eye or the pituitary gland, then the neuroradiology subspecialty is assigned to the radiology order. At step 48, if it is determined that the imaged body part is the patient chest, an abdominal region or an internal organ or gland, then the radiology body imaging subspecialty is assigned to the radiology order. At step 50, if it is determined that the imaged body part is an extremity, a muscle, a joint, a skeletal part, or a bone, then the musculoskeletal radiology subspecialty is assigned to the radiology order. At step 52, if the study description comprises an interventional part, the interventional radiology subspecialty is assigned to the radiology order. At step 54, if angiography is part of the study description, then the angiography subspecialty is assigned to the radiology order. Finally, if the answer is no to each question 32-54, then the general radiology subspecialty is assigned to the radiology order.

In one embodiment, a single radiology subspecialty is assigned to the radiology order. In this case, as soon as a match is found at step 32-54, the flow chart is stopped. For example, if at step 32 it is determined that the age of the patient is under 18 years old, then the pediatrics radiology subspecialty is assigned to the radiology order and the steps 34-54 are not executed.

In another embodiment, more than one radiology subspecialty may be assigned to a radiology order. In this case, all of the steps 32-54 are executed.

In one embodiment, the radiology order is parsed and reference keywords are searched in the parsed text in order to identify the radiology subspecialty associated to the radiology order. It should be understood that only the study description of a radiology order may be parsed. The reference keywords may comprise complete words and/or abbreviations. For example, in order to determine whether the breast radiology is a subspecialty for the radiology order, the terms “breast”, “BREAST”, “br”, and “brst” may be searched in the parsed order. If the parsed order contains one of these terms, then the breast radiology subspecialty is assigned to the radiology order. In another example, the expression “X-ray angiography” or the abbreviation “XA” may be searched in the parsed order in order to determine whether the angiography subspecialty should be assigned to the radiology order.

While the exemplary set of rules illustrated in FIG. 2 comprises a rule about the age of the patient, rules about the imaging modality, rules about the imaged body part, and rules about the study description, it should be understood that the set of rules may comprise more or less rules. For example, the set of rules may only comprise rules about the imaging modality. In another embodiment, the set of rules may comprise rules about the imaging modality and rules about the imaged body part.

It should be understood that the set of rules illustrated in FIG. 2 is exemplary only, and may be modified.

Referring back to FIG. 1, once it has been determined, the at least one subspecialty of the radiology order is compared to the qualification subspecialty(ies) of each reader, at step 16. A qualification subspecialty is a radiology subspecialty for which a reader is qualified, and indicates the type of medical images that the reader is qualified or permitted to read or analyze. A database contains information about the readers including at least the name of the readers or a reader ID for each reader, and the qualification subspecialty(ies) associated with each reader. The qualification subspecialty(ies) may be set by an administrator for each reader. Alternatively, the qualification subspecialty(ies) of a given reader may be set by the given reader himself or herself.

At step 16, the qualification subspecialty(ies) of each reader is(are) retrieved from the database and compared to the radiology subspecialty(ies) of the radiology order in order to determine positive matches between the qualification subspecialty(ies) of the readers and the subspecialty(ies) of the radiology order. A positive match occurs when one qualification subspecialty of a reader corresponds to one radiology subspecialty of the radiology order. When only one radiology subspecialty is assigned to a radiology order, only one positive match is possible. However, when more than one radiology subspecialty is assigned to a radiology order, then the number of positive matches may be greater than one. In another embodiment, a positive match occurs only when each one of all the subspecialties of a radiology order are matched by a respective reader subspecialty. For example, if two given subspecialties are associated with a radiology order, then a positive match only occurs when a reader has the two given subspecialties.

In one embodiment, the database may further comprise a preference subspecialty for at least some of the readers. In one embodiment, a preference subspecialty indicates a preference of the reader, and is defined by the reader himself. In another embodiment, the preference subspecialty may be set by a party other than the reader such as an administrator and may not correspond to a personal preference of the reader. For example, such a preference subspecialty may be used to give readers exposure to a broad set of radiology subspecialties. In this case, a preference subspecialty may be randomly or pseudo-randomly chosen amongst all possible order subspecialties, and the preference subspecialty may be changed over time for the reader. For example, a reader may be assigned a different preference subspecialty for each work shift.

It should be understood that a preference subspecialty assigned to a reader may not correspond to one of the qualification subspecialties of the reader. For example, a reader may have a single qualification subspecialty such as the neuroradiology subspecialty and his preference subspecialty may be the pediatric subspecialty. Alternatively, a reader preference subspecialty may correspond to one of the reader's qualification subspecialty. For example, a reader may have two qualification subspecialties such as the neuroradiology and pediatric subspecialties and have the pediatric subspecialty as preference subspecialty.

In one embodiment, the qualification and/or preference subspecialties of a given reader may change from one work shift to another. In the same or another embodiment, the qualification and/or preference subspecialties of a given reader may vary as a function of the role that the given reader is fulfilling. For example, a given reader may be substituting for another reader, and thus assuming a different set of duties. It should be understood that the changes to the qualification and/or preference subspecialties of the readers are reflected in the database. For example, the database may comprise given qualification and/or preference subspecialties for a given reader as function of work shifts and/or the role fulfilled by the reader.

In an embodiment in which qualification and preference subspecialties are assigned to readers, a positive match occurs when a reader qualification subspecialty corresponds to a subspecialty assigned to a radiology order. If only a reader preference subspecialty corresponds to an order subspecialty, then the reader may not be considered as being qualified for reading the radiology order.

In an embodiment in which a required subspecialty and optionally a preferred subspecialty are assigned to a given radiology order and a qualification subspecialty and optionally a preference subspecialty are assigned to readers, a positive match only occurs if the reader qualification subspecialty corresponds to the order required subspecialty. For example, if the reader preference subspecialty corresponds to the order required subspecialty and/or to the order preferred subspecialty and/or the reader preference subspecialty corresponds to the order preferred subspecialty but the reader qualification subspecialty does not correspond to the order required subspecialty, then there is no positive match and the reader is disqualified.

Referring back to FIG. 1, once the reader subspecialty(ies) has(have) been compared to the radiology subspecialty(ies) of a radiology order, a score is assigned to each reader based on the results of the comparison, at step 18.

In one embodiment, a same score is assigned for each positive match. In one example, two different radiology subspecialties may be assigned to a radiology order, such as the pediatric radiology and the neuroradiology subspecialties. For each reader having the pediatric radiology subspecialty, a first score is assigned, e.g. a score of 1. For each reader having the neuroradiology subspecialty, a second score is assigned. In this embodiment, the second score is equal to the first score, e.g. a score of 1. For each reader who has not the pediatric radiology subspecialty or the neuroradiology subspecialty, a third score different and lower than the first and second score is assigned, e.g. a score of 0. As a result, in this example, a reader who has both the pediatric radiology and neuroradiology subspecialties is assigned a score of 2, a reader who has only one of the two order subspecialties is assigned a score of 1 while a reader who has none of the order subspecialties is assigned a score 0.

In another embodiment, a different score may be assigned to different positive matches. For example, weighting factors may be stored in memory and be assigned to the subspecialties assigned to a radiology order such as when the order subspecialties are hierarchically configured. For example, the memory may comprise a database comprising a list of subspecialties and a corresponding weighting factor for each subspecialty. In this case, the value of the weighting factors may be indicative of the hierarchy between the order subspecialties. Referring to the above example, the pediatric radiology may be considered as more important than the neuroradiology subspecialty, and therefore ranked first while the neuroradiology subspecialty may be ranked second. In this case, the weighting factor assigned to the pediatric radiology subspecialty may be greater than that assigned to the neuroradiology subspecialty. For example, a weighting factor of 1 may be assigned to the pediatric radiology subspecialty while a weighting factor of 0.5 may be assigned to the neuroradiology subspecialty in order to reflect the established hierarchy between the two order subspecialties. A same score, e.g. a score of 1, is assigned to each positive match and the assigned score is multiplied by the weighting factor. A reader having the two order subspecialties is therefore assigned a score of 1.5. A reader having only the pediatric radiology subspecialty is assigned a score of 1 while a reader having only the neuroradiology subspecialty is assigned a score of 0.5. Finally, a reader having none of the two order subspecialties is assigned a score of 0.

In an embodiment in which the order subspecialties comprise at least one required subspecialty and at least one preferred subspecialty, a same score may be provided for a positive match between a reader subspecialty and an order required subspecialty, and a positive match between a reader subspecialty and an order preferred subspecialty. In another embodiment, different weighting factors may be assigned to the required order subspecialty(ies) and to the preferred order subspecialty(ies). For example, the compliance of a reader to a required order subspecialty may be more important than the compliance to a preferred order subspecialty. In this case, the weighting factor assigned to a required order subspecialty may be greater than that assigned to a preferred order subspecialty. In another example, the compliance of a reader to a preferred order subspecialty may be more important than the compliance of the reader to a required order subspecialty. In this case, the weighting factor assigned to a preferred order subspecialty may be greater than that assigned to a required order subspecialty.

In an embodiment in which the reader subspecialties comprise at least one qualification subspecialty and at least one preference subspecialty, a same importance may be given to the compliance of a qualification subspecialty to an order subspecialty and the compliance of a preference subspecialty to an order subspecialty. In this case, a same score is assigned when a reader qualification subspecialty corresponds to an order subspecialty and when a reader preference subspecialty corresponds to an order subspecialty. In another embodiment, different weighting factors may be assigned to the reader qualification subspecialty(ies) and the reader preference subspecialty(ies). For example, the compliance of a reader qualification subspecialty to an order subspecialty may be more important than the compliance of a reader preference subspecialty to an order subspecialty. In this case, the weighting factor assigned to a reader qualification subspecialty may be greater than that assigned to a reader preference subspecialty. In another example, the compliance of a reader preference subspecialty to an order subspecialty may be more important than the compliance of a reader qualification subspecialty to an order subspecialty. In this case, the weighting factor assigned to a reader preference subspecialty may be greater than that assigned to the reader qualification subspecialty.

In the following several examples, methods for assigning scores are presented. In a first example, a radiology order is assigned a single subspecialty such as the neuroradiology subspecialty. A first reader has the neuroradiology subspecialty as both qualification and preference subspecialties. A second reader has no qualification or preference subspecialty. In this case, the first reader is provided with a non-zero subspecialty match score, e.g. a score of 1, while the second reader is assigned a null subspecialty match score since the second reader is not qualified to read the medical image corresponding to the radiology order. The second reader is therefore excluded from reading the medical image.

In a second example, a radiology order is assigned the neuroradiology subspecialty. A first reader has the neuroradiology subspecialty as both a qualification subspecialty and a preference subspecialty. A second reader has the neuroradiology subspecialty as a qualification subspecialty, but has no preference subspecialty. In this case, the first reader is assigned a subspecialty match score that is greater than the subspecialty match score assigned to the second reader. For example, both the first and second readers may be assigned a score of 1 because of the match between their qualification subspecialty with the order subspecialty. In addition, the first reader may be assigned a second score of 1 because of the match of his preference subspecialty with the order subspecialty. As a result, the total score of the first reader is equal to 2 while the total score of the second reader is equal to 1.

In a further example, a radiology order is assigned the pediatric radiology subspecialty as required subspecialty and the pediatric radiology and neuroradiology subspecialties as preferred subspecialties. For the preferred subspecialties, the pediatric radiology has a greater hierarchy than the neuroradiology subspecialty. A first reader has the neuroradiology subspecialty as both qualification subspecialty and preference subspecialty. A second reader has the pediatric radiology and the neuroradiology subspecialties as qualification subspecialties but only the neuroradiology subspecialty as preference subspecialty. A third reader has the pediatric subspecialty as both qualification and preference subspecialties. In this case, the first reader is assigned a score of 0 since he does not possess the required order subspecialty, namely the pediatric radiology subspecialty. Since they each possess the required order subspecialty, the second and third readers are qualified to read the radiology order and are therefore assigned a non-zero score. However, the third reader is assigned a score greater than that of the second user since the preference subspecialty of the third reader matches an order preferred subspecialty having a greater hierarchy than that of the order preferred subspecialty matched by the preference subspecialty of the second reader. For example, both the second and third readers may be each assigned a score of 1 since their qualification subspecialty matches the required subspecialty of the order. The second reader is further assigned a score of 0.5 since his preference subspecialty matches the preferred subspecialty that has a second degree of hierarchy and a weighting factor of 0.5 is assigned to this preferred subspecialty. As a result, the second reader obtains a score of 1.5. The third reader is further assigned a score of 1 since his preference subspecialty matches the preferred order subspecialty having the greatest hierarchy and a weighting factor of 1 is assigned to this preferred order subspecialty. As a result, the third reader obtains a total score of 2, and is considered as the most adequate reader for the order since he obtains the greatest total score.

It should be understood that assigning a score to each reader as a function of their subspecialty is equivalent to ranking the readers.

Referring back to FIG. 1, the determined match score of each user for a same radiology order is outputted. For example, the determined match scores may be stored in memory along with an identification of each corresponding reader and an identification of the radiology order for which the scores have been calculated. In another example, the determined match scores may be transmitted to a display unit to be displayed thereon.

In one embodiment, the method 10 further comprises a step of normalizing the determined match scores. In one embodiment, a non-linear transfer function is used as a normalizing function in order to compress or bias the range of possible match scores.

In one embodiment, the range of normalized scores is restricted to the range of 0.0 to 1.0, and within that range, the normalization calculation is constrained to implement the following requirements:

a match score of 0 must be mapped to a normalized score of 0; and

the mapping between the match scores and the normalized scores must be monotonic, so that it does not alter the relative order of incoming match scores while match scores that were previously different may be however mapped to an identical normalized score.

It should be understood that any adequate normalization methods may be used. In one embodiment, quantization of the match scores may be used as a normalization method. In another embodiment, thresholding may be used. For example, all match scores being greater than a threshold match score may be mapped to a normalized score of 1 while all match scores being less or equal to the threshold match score may be mapped to a normalized score of 0.

In one embodiment, the normalization method consists in first determining the maximum match score determined at step 18. If the maximum match score is equal to zero, then all of the readers are assigned a normalized score equal to zero. If the maximum match score is different from zero, then all of the match scores determined at step 18 are divided by the identified maximum match score.

In an alternate embodiment, a transfer function such as a sigmoid transfer function is used as a normalization function. For example, the following sigmoid function may be used:

5(t)=1/(1+ê(−t))

where t is a match score determined at step 18 and S(t) is its corresponding normalized score.

In one embodiment, such a sigmoid transfer function allows mapping all relatively high match scores to a preference score of 1.0, and all relatively low match scores to a preference score of 0.0. The benefit would be that the intermediate match scores would be resolved with increased distinctive power amongst themselves once mapped to the normalized score space.

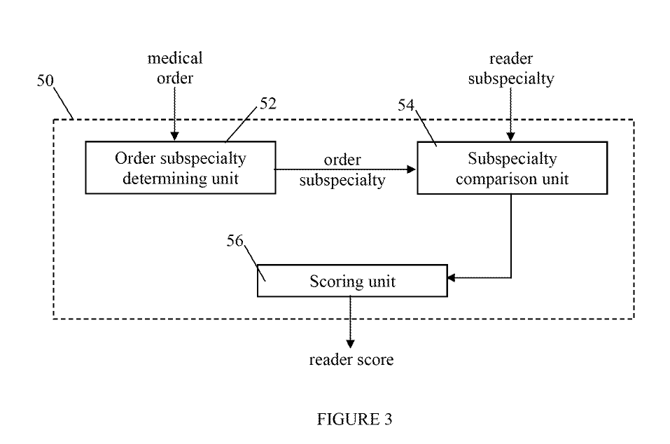

It should be understood that the above computer-implemented method 10 may be implemented as a system as illustrated in FIG. 3. The method 10 may also be implemented as a device comprising at least a processing unit, a communication unit for transmitting and receiving data, and a storing unit for statements and/or instructions that when executed by the processing unit, perform the steps of the method 10. The method 10 may also be embodied as a computer program product comprising a computer readable memory storing computer executable statements/instructions thereon that when executed by a processing unit perform the steps of the method 10.

FIG. 3 illustrates one embodiment of a system 50 for automatically ranking an ability of readers to read a medical image. The system 50 comprises an order subspecialty determining unit 52, a subspecialty comparison unit 54, and a scoring unit 56. In one embodiment, the subspecialty comparison unit 54 and the scoring unit 56 may be integrated together so that the subspecialty comparison unit 54 is adapted to perform the functionalities of the scoring unit 56.

In one embodiment, the order subspecialty determining unit 52, the subspecialty comparison unit 54, and the scoring unit 56 are each provided with at least a processing unit, a memory, and a communication module for receiving and/or transmitting data. In another embodiment, at least two of the order subspecialty determining unit 52, the subspecialty comparison unit 54, and the scoring unit 56 may share the same processing unit, memory, and/or communication module.

The system 50 may further comprise at least one database (not shown) on which rules such as fixed rules, text parsing rules, time-of-day rules, ranking rules, and/or the like may be stored and accessed by the order subspecialty determining unit 52, the subspecialty comparison unit 54, and/or the scoring unit 56. The order subspecialty determining unit 52 is adapted to receive a radiology order corresponding to the medical image for which the reader qualification is to be assessed. The order subspecialty determining unit 52 is further adapted to determine at least one subspecialty that corresponds to the received radiology order using the above-described method. The subspecialty comparison unit 54 is adapted to receive the order subspecialty determined by the order subspecialty determining unit 52 in addition to the subspecialties of each reader. The subspecialty comparison unit 54 is further adapted to compare the order subspecialty(ies) to the subspecialties of each reader in order to identify positive matches using the above-described method. The scoring unit 56 is adapted to receive the results of the comparison from the subspecialty comparison unit 54, and assign a match score to each reader using the above-described method.

In another embodiment, the database comprises procedure codes and at least one corresponding subspecialty for each procedure code. The order subspecialty determining unit 52 is then adapted to extract at least one procedure code from the radiology order and determine at least one corresponding subspecialty using the extracted procedure code(s) and the database.

Once the qualified readers have been determined using the method 10 or the system 50, it is determined which qualified readers are available for analyzing the radiology order, and their respective period of availability, i.e. how much longer they are expected to remain available. It should be understood that any adequate method for determining which qualified readers are presently available and their respective period of availability may be used.

In one embodiment, historical information about the connections of the readers to the distribution engine is used for determining the availability of the readers and their respective period of availability. The historical information comprises information about the work shifts of the readers such as the time at which the readers connect to the distribution engine for starting analyzing orders (i.e. the start time of a work shift), the time at which the readers disconnect (i.e. the end time of the work shift), and the weekday(s) for each work shift. Using statistics, it is possible to determine a mean shift duration for each work shift of the readers.

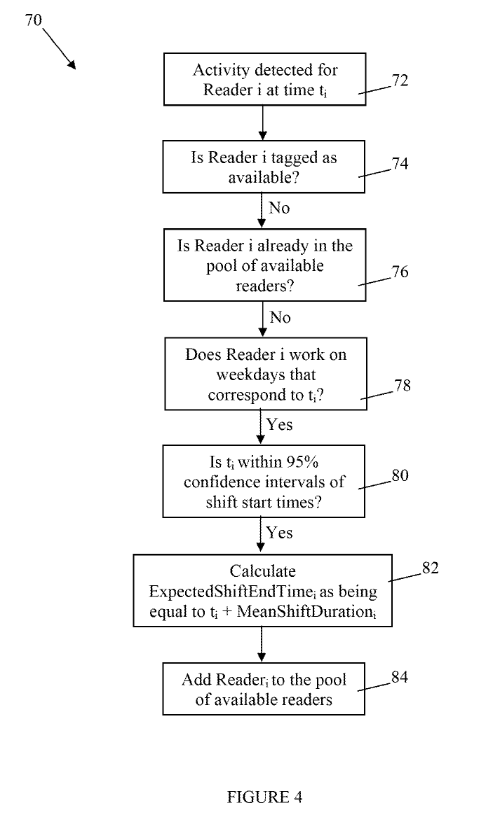

FIG. 4 illustrates one exemplary computer-implemented method 70 to be followed by the distribution engine for determining whether a reader is available and his expected work shift end. Once, at step 72, the activity of the reader is detected at time t, the engine verifies whether the reader is tagged as being available or not at step 74. If the reader is tagged as being available, then the engine considers the reader as being available and stops the method 70. If not, the engine verifies whether the user is already included in the list of available readers at step 76. If not, the engine determines at step 78 whether the weekday at which the readers connect corresponds to a weekday stored in the database, i.e. a weekday on which the reader is supposed to work. If there is no match, the reader is considered as being unavailable. Otherwise, the engine determines whether the time t for which activity of the reader has been detected is within 95% confidence intervals of the shift start times of the reader, at step 80. If not, the reader is considered as unavailable. Otherwise, the engine then determines the expected end time of the work shift of the reader using the mean work shift duration stored in the database, at step 82, and the reader is added to the pool of available readers at step 84. It should be understood that knowing the expected end of the work shift for a reader is equivalent to knowing how much longer the reader is expected to remain available.

Optionally, the engine may continuously check the activity of the reader. If no activity has been detected for a predetermined period of time, the engine may then change the status of the reader and remove him or her from the list of available readers.

While in the present description the qualified readers are first identified, and then the availability of the qualified readers is determined, it should be understood that the available readers may first be determined, and the qualified readers may then be identified amongst the available readers.

Once the qualified and available readers have been determined using the above-described methods, the readers who may read the radiology order by its due-in-time requirement are identified amongst the qualified and available readers. The due-in-time requirement of a radiology order corresponds to the deadline for completing the analysis of the medical image(s) associated with the radiology order. In one embodiment, the due-in-time requirement is contained within the radiology order.

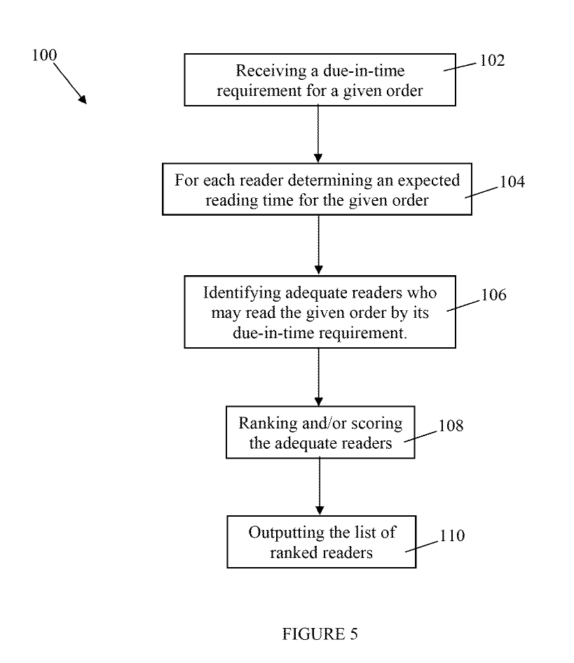

FIG. 5 illustrates one embodiment of a computer-implemented method 100 for identifying and ranking and/or scoring the readers who may read the radiology order by its due-in-time requirement. The method 100 is executed by a computer machine that comprises at least a communication means for receiving and/or transmitting data, a processing unit and a memory having stored thereon statements and/or instructions that, when executed by the processing unit, perform the steps of the method 100.

At step 102, the processing unit is used to receive the due-in-time requirement of the given radiology order to be analyzed.

In one embodiment, the due-in-time requirement may be determined using information contained in the given radiology order. For example, relevant information for determining the due-in-time requirement may be determined from metadata fields. In another example, the relevant information for determining the due-in-time requirement may be obtained by parsing the given radiology order.

The timestamp that was generated when the radiology order becomes ready, usually when all imaging is completed is the start time for due in time calculations. Then based on order properties such as the order priority status, a deadline for the given radiology order is determined. For example, critical order priorities such as STAT orders may be due within 1 hour or 4 hours, depending on client, site or Service Level Agreement (SLA) terms. In another example, routine orders may be due within 24 or 48 hours of the order being deemed ready. The deadlines corresponding to order priorities may be stored in a database. In another example, a set of rules or policies that can be used to calculate the given order's due in time requirement may be stored in a database. It should be understood that the rules or policies for calculating the due-in-time requirement may differ by clients and/or sites. The different due-in-time calculation rules or policies may be configurable for different clients or sites.

At step 104, the order expected reading time is determined for each reader. The order expected reading time for a given reader corresponds to the expected time to be taken by the given reader to analyze the medical image(s) associated with the radiology order.

In one embodiment, the order expected reading time is independent of the readers. In this case, all of the readers are provided with a same order expected reading time, and the order expected reading time may vary from one radiology order to another depending on the complexity of the radiology order for example. The order expected reading time is then dependent on at least one parameter such as the modality, the information contained in the study description, the image body part, any contrast agent used for imaging the body part, the patient age, the number of medical images associated with the radiology order, relevant priors, the order subspecialty(ies), the current procedural terminology code, and/or the like. The order expected reading time may then be determined from a database containing reference reading times for respective parameter values. For example, if the order expected reading time depends only on the modality, the database contains a respective reference reading time for each possible modality. It should be understood that the order parameter(s) used for determining the expected reading time may be contained within the radiology order. In this case, the parameter information is first extracted from the radiology order using the above-described method.

In one embodiment, the reader-independent order expected reading time is calculated based on historical data. The historical data may comprise data relative to past orders that were previously analyzed by all of the readers of a given group of readers. For example, the reading time mean for a given modality order may be determined using the average time taken by the readers of the group for analyzing previous orders having the given modality. Then, each user is assigned the calculated reading time mean as their expected reading time for any order having the given modality.

In another embodiment, the order expected reading time is further reader dependent. In this case, the expected reading time for a given radiology order may vary from one reader to another depending on the skills of the readers for example. In this case, for each reader there corresponds a respective order expected reading time which depends on at least one parameter such as the modality, the information contained in the study description, the image body part, any contrast agent used for imaging the body part, the patient age, the number of medical images associated with the radiology order, relevant priors, the order subspecialty(ies), the current procedural terminology code, and/or the like. As a result, different readers may have a different expected reading time for a same order. It should be understood that each reader may be provided with a database associating reference reading times to the parameter values.

In one embodiment, the order expected reading time is calculated based on reader-specific historical data. In this case, the historical data used for calculating the order expected reading time comprises data relative to past orders that were previously analyzed by the given reader only. For example, the reading time mean for a given modality order may be determined using the average time taken by the given reader for analyzing all previous orders having the given modality.

In the same or another embodiment, the order expected reading time depends on at least one of the following parameters: the order relative value units (RVUs) value, the order subspecialty(ies), the reader experience in years, the reader subspecialty(ies), a measure of the reader subspecialties match with the order subspecialties, and/or the like. RVUs are an industry recognized measure of work effort for reimbursement purposes. As described below, the order expected reading time can be approximated from the order RVU value and reader RVU throughput rate.

In one embodiment, a library of expected reading time models (ERT models) is stored in a database. The ERT models are built from data mining and analysis on historical data of previous analysis of radiology orders by the readers. It should be understood that the models may be reader-specific if the historical data is reader-specific. The step of determining the order expected reading time comprises selecting an adequate model as a function of the radiology order and optionally the reader. If there is no historical data available, back-tested industry defaults statistics and well vetted models may be used for the determination of the order expected reading time.

In one embodiment, the analysis of the historical orders for building the ERT models includes the following steps: cleaning/preparing the historical data, exploring the historical data to find relevant parameters/factors, forming ERT models, and validating the ERT models. The historical data needs to be cleaned/prepared to deal with errors, missing data, and/or removal of outliers. For building the ERT models, the historical reading time per order needs to be extracted or estimated from the data. If not available directly, the historical reading time per order may be estimated from examining audit logs of reading activity on an order to detect the first opening and last closing of order images prior to order report dictation. It should be understood that any suitable method to compute an estimate of the historical reading time may be used. Once the historical reading times are available either through direct availability from the data or using any suitable estimation method, the ERT models are built.

The exploratory data analysis step involves identifying relevant parameters/factors for the ERT models. A linear regression model or a non-linear regression model such as a polynomial model or a spline model may be used for example. The ERT models are built by fitting model parameters based on the data. This is done iteratively by considering different sets of parameters/factors to find statistically relevant parameters/factors.

In order to measure the performance of the ERT models, the data is partitioned into training and testing sets. The ERT models are then trained/fit on the training set and then validated/tested on the testing set. Error measures such as the mean square error (MSE) or a penalized MSE for model complexity may be used for evaluating the model performance. However, it should be understood that any appropriate error measure may be used to evaluate model performance. Finally, the ERT models having an acceptable level of error are then implemented into the ERT library.

The step of selecting an ERT model consists in selecting the most specific model available, such as using a reader specific model over a generic model. In one embodiment, there may be a series of fallback ERT models that are used if more specific models, which generally require more information on a greater number of factors, cannot be used because the required factors are not available from an order and reader input pair. For example, if a reader specific ERT model is not available for a given reader, a simpler ERT model based on order modality and study anatomy may be used instead. If the study anatomy is not available for a given radiology order, then a fallback ERT model such as one based only on the order modality may be used instead, for example.

In some embodiments, the expected reading time model can be based on historical workflow data at a specific client site. In this case, the historical data from the specific client site is used to tune or fit the model parameters for the ERT models in the ERT library, which are then specific to the site.

In some embodiments, the expected reading time model parameters can be updated dynamically. For example, the ERT models may be periodically updated using new historical data.

Once the expected reading time for the radiology order has been determined for each reader, the readers who may analyze the radiology order by its due-in-time requirement are identified at step 106. Each reader has a schedule of assigned orders that he or she has to analyze, and each assigned order has a corresponding due-in-time requirement by which it has to be analyzed. A schedule of assigned orders is a temporally ordered sequence of radiology orders assigned to a reader. In a schedule of assigned orders of a given reader, the assigned orders are temporally ordered or ranked so that the assigned order having the first position has to be analyzed first by the given reader, the assigned order having the second position has to be analyzed after the analysis of the first order is completed, the assigned order occupying the third position has to be analyzed after the analysis of the second assigned order is completed, etc.

In order for a new order to be added to the schedule of assigned orders of a given reader, the given reader should be able to read all of the assigned orders by their respective due-in-time requirement, i.e. the given reader should be able to analyze the order newly added to his or her schedule by its corresponding due-in-time requirement and the orders already existing before the addition of the new order by their respective due-in-time. If, when the new order is added to the schedule of a given reader, at least one order cannot be read by its respective due-in-time requirement, then the given reader is considered as being not capable to read the new order. The readers for which the new order may be added to their respective schedule while allowing all of the orders contained in the updated schedule to be analyzed by their respective due-in-time requirement are considered as being adequate readers and are added to a list of adequate readers. The other readers are therefore dismissed and not included in the list since they cannot analyze the new order and their already assigned orders by their respective due-in-time requirement.

In one embodiment, a slack value is determined for each order existing in the schedule of a reader before the insertion of the new order therein. The slack value of a given existing order corresponds to the amount of time by which the given existing order is expected to be completed before its respective due-in-time requirement. Orders with greater slack values have more room to be delayed in execution. Orders with small slack values, generally cannot be delayed by much time. Since they are temporally ordered, the existing orders present in the schedule are each provided by a start time at which the reader is expected to start analyzing the order, and an end time at which the reader is expected to have completed the analysis of the order. The slack value of a given order corresponds to the time difference between the due-in-time requirement and the end time for the given order.

Once the slack value has been determined for each order existing in the schedule of a given reader, it is determined whether the new order may be added to the schedule. In order to determine whether the new order may be introduced in the schedule before the first existing order, the expected reading time of the new order is compared to the slack value of the first existing order. If the slack value of the first existing order is less than the expected reading time of the new order to be added to the schedule, then the new order cannot be added to the schedule before the first existing order. If the slack value of the first existing order is equal to or greater than the expected reading time of the new order to be added and the new order can be read by its due-in-time requirement when inserted in such a position in the schedule, then the new order can potentially be added to the schedule before the first existing order. The new order is then added to the schedule before the first existing order which delays the other existing orders by an amount of time corresponding to the expected reading time of the new order. It is then verified whether each delayed existing order comprised between the second existing order and the last existing order can be completed by its respective due-in-time requirement. If at least one of these delayed existing orders cannot be completed by its corresponding due-in-time requirement due to the addition of the new order before the first existing order, then it is determined that the new order cannot be added to the schedule before the first existing order.

In order to determine whether the new order may be introduced in the schedule between the first and second existing orders, the expected reading time of the new order is compared to the slack value of the second existing order. If the slack value of the second existing order is less than the expected reading time of the new order to be added to the schedule, then the new order cannot be added to the schedule between the first and second existing orders. If the slack value of the second existing order is equal to or greater than the expected reading time of the new order to be added and the new order can be read by its due-in-time requirement when inserted in such a position in the schedule, then the new order can potentially be added to the schedule between the first and second existing orders. The new order is then added to the schedule between the first and second existing orders which delays the other existing orders present in the schedule by an amount of time corresponding to the expected reading time of the new order. It is then verified whether each delayed existing order comprised between the third existing order and the last existing order can be completed by its corresponding due-in-time requirement. If at least one of these delayed existing orders cannot be completed by its corresponding due-in-time requirement due to the addition of the new order between the first and second existing orders, then it is determined that the new order cannot be added to the schedule between the first and second existing orders.

In order to determine whether the new order may be introduced in the schedule between the second and third existing orders, the expected reading time of the new order is compared to the slack value of the third existing order. If the slack value of the third existing order is less than the expected reading time of the new order to be added to the schedule, then the new order cannot be added to the schedule between the second and third existing orders. If the slack value of the third existing order is equal to or greater than the expected reading time of the new order to be added and the new order can be read by its due-in-time requirement when inserted in such a position in the schedule, then the new order can potentially be added to the schedule between the second and third existing orders. The new order is then added to the schedule between the second and third existing orders which delays the other existing orders present in the schedule by an amount of time corresponding to the expected reading time of the new order. It is then verified whether each delayed existing order comprised between the fourth existing order and the last existing order can be completed by its corresponding due-in-time requirement. If at least one of these delayed existing orders cannot be completed by its corresponding due-in-time requirement due to the addition of the new order between the second and third existing orders, then it is determined that the new order cannot be added to the schedule between the second and third existing orders.

The method is repeated between existing pairs of successive orders in the schedule until it is determined whether the new order can be added to the schedule between the penultimate existing order and the last existing order. The expected reading time of the new order is then compared to the slack value of the last existing order. If the slack value of the last existing order is less than the expected reading time of the new order to be added to the schedule, then the new order cannot be added to the schedule between the penultimate and last existing orders. If the slack value of the last existing order is equal to or greater than the expected reading time of the new order to be added and the new order can be read by its due-in-time requirement when inserted in such a position in the schedule, then the new order can potentially be added to the schedule between the penultimate and last existing orders. The new order is then added to the schedule between the penultimate and last orders which delays the end time of the last existing order by an amount of time corresponding to the expected reading time of the new order. The delayed end time of the last existing order is then compared to the end time of the period of availability of the reader. If the delayed end time of the last existing order is before and concurrent with the end time of the period of availability of the reader, then the new order can be added between the penultimate and last existing orders. Alternatively if the delayed end time of the last existing order is after the end time of the period of availability of the reader, then the new order cannot be added between the penultimate and last existing orders. If the period of availability of the reader is unknown, the related test may be omitted.

In order to determine whether the new order can be added after the last existing order, the new order is added after the last existing order and the end time at which the analysis of the new order is expected to be completed by the given reader is computed. If the new order can be read by its due-in-time requirement when inserted in such a position and the end time of the new order is before or concurrent with the end time of the period of availability of the given reader, then the new order can be added to the schedule after the last existing order. Alternatively, if the new order can be read by its due-in-time requirement when inserted in such a position but the computed end time of the new order is after the end time of the period of availability of the reader, then the new order cannot be added to the schedule. If the new order cannot be read by its due-in-time requirement when inserted after the last existing order, then the new order cannot be added to the schedule. If the period of availability of the reader is unknown, the related test may be omitted.

In an embodiment in which the period of availability of a reader is unknown beforehand, the step of verifying whether the delayed end time of the last existing order is before or concurrent with the end time of the period of availability of the reader is omitted.

In another embodiment, the method for determining whether a new radiology order may be inserted in a reader schedule is performed in a single scan of the reader schedule. In this case, two conditions must be met for an order to be inserted at a given position within the reader schedule. The first condition is that the new order when inserted at a given position must be read by its due-in-time requirement. The second condition is that, when the new order is inserted at the given position within the reader schedule, all of the already existing orders positioned after the new order must have a respective slack value that is greater than or equal to the expected reading time of the new order.

For example, a schedule may comprise N already assigned orders. In this case, N+1 potential insertion points exist for the new order. In the following, the possible insertion point is denoted as K and the value of K may vary from 1, i.e. when the new order is inserted before the first already assigned order, to N+1, i.e. when the new order is inserted after the last already assigned order.

The method starts by setting the first position of the schedule with K=1 as being the candidate insertion point for the new order into the existing schedule, i.e. inserting the new order before the first already assigned order in the schedule. The first condition must be satisfied by any candidate insertion position. If the first condition does not hold at a candidate insertion position K, then the new order cannot be read by its due-in-time requirement by the reader. If the first condition holds for a candidate position K, then it is verified whether the second condition also holds. This is because the new order if inserted at position K in the existing schedule will delay all following orders in the schedule by an amount of time equal to the new order's expected reading time. If this delay causes any following order at position J≧K to not be readable by its respective due-in-time requirement, then the insertion position K is not adequate. Clearly, existing orders in the schedule that come before a possible insertion point for the new order are not delayed by the new order.

The check for the second condition occurs in a sequential scan of the orders in the existing schedule. If there is a violation of the second condition at position J where J≧K, then the candidate insertion K is simply updated to the next position in the schedule that is yet to be checked, i.e. K is updated to position J+1. The new candidate insertion position K is then checked to see if the first and second conditions are satisfied. Otherwise, if the second condition holds at current position J, then the candidate insertion position K for inserting the new order is still adequate and not updated. The check for the second condition continues onto the next order in the schedule, i.e. the order at position J+1 is checked next. This is repeated until the last order in the schedule has been checked.

The method ends when the first condition is first violated and/or when all orders in the schedule have been checked. At the end of the method, if it satisfies both the first and second conditions, then a candidate position K is a viable insertion point for the new order. In fact, this position is the minimal or earliest possible insertion position for inserting the new order into the existing schedule because K is only updated as needed when the first and/or second conditions (i.e. the first or second condition, or both conditions) is violated during the sequential schedule scan checks.

If no such viable insertion position K is found in using the above-described method, then the new order cannot be inserted before any orders in the existing schedule. Then the position after the last already assigned order is considered a candidate insertion point. If the new order can be read by its due-in-time requirement when inserted after the last already assigned order, then the reader is an adequate reader for the new order.

It should be understood that there may be more than one adequate position to insert the new order into a reader schedule of already assigned orders. In this case, the adequate positions for insertion of the new order forms a contiguous range [minInsert, maxInsert], where minInsert is the earliest possible position and maxInsert is the latest position to insert the new order into the existing schedule. If minInsert, i.e. the smallest/earliest position, satisfies the condition that all orders following the new order when inserted at minInsert in the existing schedule can still be read by their respective due-in-time requirement, then any position after minInsert for inserting the new order will also satisfy this condition given the new order's expected reading time. The position of maxInsert is the latest insertion point such that the new order can be read by its due-in-time requirement. This is an additional straightforward check to the main check of the second condition that any existing order after a candidate insertion position in the schedule can still be read by its respective due-in-time requirement, if preempted by the new order being read earlier.

In a preferred embodiment, a range of viable insertion positions for inserting a new order into a reader's existing schedule of already assigned orders is determined as follows. The above-described method is used to find the earliest insertion position, i.e. minInsert, for inserting the new order into a given reader's existing schedule. To find the last possible insertion position, i.e. maxInsert, for inserting the new order, there is an additional check that is needed as the method scans the existing schedule for both the first and second conditions. Given a candidate insertion position K, maxInsert is initialized to K. Then the above-described method is extended to during its check of the current order J (J≧K, with K being a candidate insertion position) for satisfying the second condition, to also check whether the new order if inserted at current position J can still be read by its due-in-time requirement. If so, maxInsert is updated to be J. As the method moves onto the next order to check in the schedule, i.e. position J+1 is next, then maxInsert can be updated accordingly if the new order can still be read by its due-in-time at position J+1. The range of viable insertion positions for inserting the new order in the existing schedule is then [minInsert, maxInsert], where minInsert is equal to K. This range is determined, or lack thereof, once the above described method has finished scanning the existing schedule to check whether all sufficient conditions are satisfied.

In one embodiment, the above-described method for determining the time positions within a reader schedule at which a new order is insertable is stopped as soon as a first adequate insertion time position is found. In another embodiment, the above-described method is completed until the end so that more than one adequate time position at which the new order can be inserted within the schedule may be identified.

In an embodiment in which more than one insertion time position are possible for a new order, the method 100 further comprises a step of selecting one of the possible insertion points. When more than one insertion position for a new order exists, at least two different schedules are possible for the reader, each possible schedule corresponding to a respective insertion position for the new order.

In one embodiment, the selection of a given insertion point for the new order is performed by ranking the possible schedules for the reader as a function of at least one given parameter. The chosen insertion point may then be the given insertion point for which the corresponding possible schedule is ranked first. Examples of parameters for ranking the possible schedules comprise the total slack value, the minimum slack value, the maximum slack value, the average slack value, the variance in slack value, and the like. In one embodiment, the ranking of the possible schedules is done as a function of the increasing value of the parameter. In this case, the possible schedule having the lowest value for the parameter is ranked first. In another embodiment, the ranking of the possible schedules is done as a function of the decreasing value of the parameter. In this case, the possible schedule having the greatest value for the parameter is ranked first.

For example, the total slack value for each possible schedule is calculated by adding together the slack values of all of the orders contained in each possible schedule. The possible schedule having the greatest total slack value is then chosen to determine the adequate insertion position for the new order within the schedule of the reader, i.e. the chosen insertion position for the new order corresponds to the position at which the new order has been inserted in the possible schedule having the greatest total slack value. Alternatively, the possible schedule having the lowest total slack value is then chosen to determine the adequate insertion position for the new order within the schedule of the reader, i.e. the chosen insertion position for the new order corresponds to the position at which the new order has been inserted in the possible schedule having the lowest total slack value.

In another example, the minimum slack value for all of the orders contained in each possible schedule is identified for each possible schedule. The possible schedule having the greatest minimum slack value is then chosen to determine the adequate insertion position for the new order within the schedule of the reader, i.e. the chosen insertion position for the new order corresponds to the position at which the new order has been inserted in the possible schedule having the greatest minimum slack value. Alternatively, the possible schedule having the lowest minimum slack value is then chosen to determine the adequate insertion position for the new order within the schedule of the reader, i.e. the chosen insertion position for the new order corresponds to the position at which the new order has been inserted in the possible schedule having the lowest minimum slack value.

In another embodiment, the selected insertion position for the new order corresponds to the latest possible insertion position in order to avoid starvation of the orders existing in the schedule before the insertion of the new order.

In a further embodiment, the selected insertion position for the new order corresponds to the earliest possible insertion position.

It should be understood that the above-described methods for selecting a given insertion position for a new order amongst a plurality of possible insertion positions are exemplary only, and any adequate method for selecting one of the possible insertion positions may be used.

In one embodiment, once it has been created, the list of selected readers, i.e. the list of the readers who are able to read the new order and their already assigned orders by their respective due-in-time requirement, is outputted. For example, the list may be stored in memory. In another example, the list may be sent to a display unit to be displayed thereon.

In another embodiment, the method 100 further comprises a step 108 of ranking and/or scoring the selected readers in order to determine the most adequate reader for analyzing the new order, as illustrated in FIG. 5. The reader that occupies the first position in the ranking is then selected as being the most adequate reader for the new order which is inserted in the schedule of the selected reader at the previously determined insertion position.

It should be understood that various adequate methods for ranking the readers may be used. In one embodiment, the ranking of the readers for which the new order can be inserted in their respective schedule is performed as a function of at least one parameter. Examples of parameters that may be used for the ranking of the readers comprise the total expected reading time for the reader schedule, the average expected reading time, the minimum expected reading time, the maximum expected reading time, the variance in expected reading time, the total RVU value for the reader schedule, the average RVU value, the minimum RVU value, the maximum RVU value, the variance in RVU value, the total slack value, the minimum slack value, the maximum slack value, the average slack value, the variance in slack value, the minimum due-in-time requirement, the maximum due-in-time requirement, the number of orders contained in the reader schedule, the number of orders having a stat priority, the number of orders to be urgently analyzed, the number of orders having a routine priority, the proportion of stat/routine orders, or the like. In one embodiment, the ranking of the readers is done as a function of the increasing value of the parameter. In this case, the reader having the lowest value for the parameter is ranked first. In another embodiment, the ranking of the readers is done as a function of the decreasing value of the parameter. In this case, the reader having the greatest value for the parameter is ranked first.

For example, the total expected reading time may be used for ranking the readers. For each reader, the total expected reading time corresponds to the addition of the expected reading times of all of the orders contained in the schedule of the reader. The readers may be ranked as a function of the increasing total expected reading time. In this case, the reader having the lowest total expected reading time is ranked first, and is selected as being the most adequate reader for analyzing the new order. Alternatively, the readers may be ranked as a function of the decreasing total expected reading time. In this case, the reader having the greatest total expected reading time is ranked first and is therefore selected as being the most adequate reader for analyzing the new order.

It should be understood that the optimization criterion applied to find the optimal insertion position for a new order in a worklist reading schedule/sequence and the optimization criterion to rank candidate readers may be different and/or applied independently of one another. In another embodiment, they may have dependencies such as, but not limited to, the ranking optimization criterion considering the feasible set of insertion positions for each candidate reader not only the optimal insertion position and/or using a ranking of the feasible positions provided by the optimal insertion criterion. The ranking process can be optimized to find the best reader for the new order in a more global nature. For example, the ranking process may consider all the potential feasible schedules for each candidate reader for the new order and apply an optimization criterion over this much larger set of schedules to rank the readers. The reader with the optimal potential schedule amongst all possible reader and feasible schedule pairs is ranked first. In addition, different potential schedules from the feasible insertion positions can be weighted differently in the ranking process. In one embodiment, the optimization criterion for optimal insertion position for a new order and/or the optimization criterion for ranking the readers can be configured to be specific to a client site's policies for desired work schedules or desired work assignment/distribution. It should be understood that the configuration may be different for different client sites. The different optimization criteria may be stored in a database or in a “Desired Schedule Policy” library or both.

Referring back to FIG. 5, once the adequate readers have been ranked, the ordered list of adequate readers is outputted at step 110. For example, the list may be stored in memory or transmitted to a display unit to be displayed thereon. The ordered list comprises the name or the identifier of the adequate readers. In one embodiment, the ordered list may further comprise the respective rank or score assigned to each adequate reader.

In one embodiment, the method 100 further comprises a step of creating the schedule of assigned orders for at least one reader. If, for a given reader, there exists no schedule of assigned orders, a schedule is created using the above-described method for inserting a new order in an existing schedule by inserting the assigned orders in the sequence they arrived.

In an embodiment in which the due-in-time requirement is contained within the radiology order, the method 100 further comprises a step of extracting the due-in-time requirement from the radiology order.

While in the present description the determination of the readers who may read the radiology order by its due-in-time requirement is done from the list of qualified and available readers, it should be understood that this determination may also be made from a list of unfiltered readers, a list of available readers, a list of qualified readers, or the like.

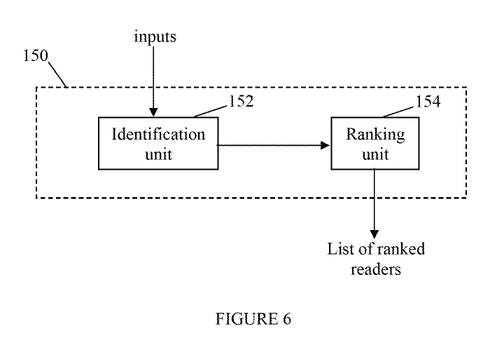

It should be understood that the above computer-implemented method 100 may be implemented as a system as illustrated in FIG. 6. The method 100 may also be implemented as a device comprising at least a processing unit, a communication unit for transmitting and receiving data, and a storing unit having stored thereon statements and/or instructions that, when executed by the processing unit, perform the steps of the method 100. The method 100 may also be embodied as a computer program product comprising a computer readable memory storing computer executable statements and/or instructions thereon that when executed by a processing unit perform the steps of the method 100.

FIG. 6 illustrates one embodiment of a system 150 for determining and ranking readers who are able to read a new order by its due-in-time requirement. The system 150 comprises an identification unit 152 and a ranking unit 154. The identification unit 152 is adapted to receive a due-in-time requirement of a new order to be assigned to a reader, a list of readers, and, for each reader, a schedule of already assigned orders comprising the respective due-in-time requirement and expected reading time for each already assigned order and the expected reading time for analyzing the new order. The identification unit 152 is adapted to determine which readers amongst the received list are able to analyze the new order by its corresponding due-in-time requirement while ensuring that all of the already assigned orders will also be analyzed by their respective due-in-time requirement, using the above-described method. In one embodiment, the identification unit 152 may comprise a receiving module adapted to receive/determine the respective due-in-time requirement and the respective expected reading time of given orders, and an identification module adapted to identify the readers who are able to analyze the new order by its corresponding due-in-time requirement.

The ranking unit 154 is adapted to receive a non-ordered list of readers who are able to analyze all of their assigned orders including the new order by their respective due-in-time requirement, and rank the readers as a function of at least one parameter, using the above-described method. In one embodiment, the ranking unit 154 is adapted to receive, for each reader, the value of the parameter used for ranking the readers. In another embodiment, the ranking unit 154 is further adapted calculate for each reader the value of the parameter used for ranking the readers. It should be understood that the readers may be ranked using more than one parameter.

It should be understood that the ranking unit 154 may be optional. In this case, the system 150 is adapted to output a non-ordered list of readers who are able to analyze all of their assigned orders including the new order by their respective due-in-time requirement.

In one embodiment, the system 150 further comprises a calculation unit (not shown) adapted to calculate for each reader the expected reading time for analyzing the new order using the above-described method.

In one embodiment each unit contained in the system 150 comprises at least a processing unit, a memory, and a communication module. In another embodiment, at least two of the units contained in the system 150 share at least the same processing unit, the same memory, and/or the same communication module.

In one embodiment, the distribution engine is further adapted to monitor the workload capacity of the readers and detect overloaded situations. A reader's workload capacity may be measured in terms of RVU throughput rates, which relates to the amount of work in terms of order RVU values that a radiologist is capable of reading over a given time period such as an hour. Thus, an RVU throughput rate indicates the reading capacity of a reader and is closely related to ERT. For example, assuming an order's RVU value and a reader's RVU throughput rate, the reader's ERT value for the order can be approximated by dividing the order's RVU value by the reader's RVU throughput rate. Therefore, a reader's workload capacity can be measured in terms of RVU or ERT values. Alternatively, both RVU and ERT values may be used in combination.

Given a reader's workload capacity expressed in either RVU and/or ERT values, conditions where a reader may be overloaded with work can be detected. The workload from the outstanding orders contained in a reader schedule can be measured and compared against their remaining work capacity for a shift. If the workload is greater than their remaining capacity, a reader is considered overloaded. Other measures for overload detection can be thresholds for maximum STAT orders workload compared to routine orders workload in either RVU or ERT terms.

In one embodiment, the detection of overload work conditions for readers can improve the performance of the distribution engine by better balancing excessive workloads across additional readers who have capacity to analyze further orders. This may be accomplished by reassigning orders from overloaded readers to other non-overloaded readers who have capacity.

In one embodiment, the reassignment of orders from overloaded readers to non-overloaded readers can be performed according to at least one optimization criteria. In one embodiment, the optimization criteria for reassigning excessive workload can be the same as the one used in the method 100. In another embodiment, the optimization criteria may be different from the one used in the method 100. Any adequate criteria that can be applied to a set of orders can be used for optimization purposes.

In one embodiment, the overload detection method can be applied over groups of readers instead of individually. A group can be determined by factors such as subspecialty, reading group, reading slots, location, and/or the like. The workload capacity of a group is defined as the sum of the workload capacity of each member of the group. In this case, the order reassignment is performed between groups instead of between individual readers.

Referring back to the method 100, it may be possible that no feasible insertion point for a new order is found in any existing reader schedule of already assigned orders. In such a case, it is expected that the new order cannot be read by its due-in-time requirement without possibly causing at least one already assigned order to miss its due-in-time requirement instead. The method 100 may comprise a rescheduling step during which a subset of given already assigned orders are reassigned using rescheduling rules stored in a database. The given orders are then removed from their existing reader schedules and they are subsequently reassigned to reader schedules at a later time using the method 100.

The reassignment may cause some of the preempted orders to miss their respective due-in-time requirement. In order to avoid such a scenario, various optimization criteria may be applied to select the orders to be reassigned, resulting in alternative schedules. For example, the choice of orders to be reassigned can be based on factors such as the order priority, Service Level Agreement (SLA) penalties, other cost functions, and/or the like. In addition, any adequate criteria that can be applied to reader schedules for optimization purposes can be used in choosing amongst competing reader schedules resulting from reassignment actions.

In one embodiment, the assignment of a new order is delayed by a predetermined amount of time when the new order cannot be assigned to any reader.

In another embodiment, a set of already assigned orders which conflict with the scheduling of the new order is reassigned. The selection of the orders to be reassigned may be based on the order priority, for example. STAT orders may be prioritized over routine orders because of their generally shorter due-in-time requirements. Therefore, routine orders with later due-in-time requirements may be chosen for reassignment.

In one embodiment, the selection of already assigned orders to be reassigned may depend on additional cost factors or at least one optimization criterion which is based on RVU values, ERT values, schedule slack values, due-in-time requirements, proportion of STAT versus routine orders metrics, SLA penalties for missing respective due-in-time requirements, and/or the like. For optimization based on cost penalties, the least costly orders are preferred for reassignment. It should be understood that the optimization criteria for selecting the orders to be reassigned are not limited to the above examples. Any adequate criteria or metrics that can be applied over a reader schedule may be used as optimization criteria to select the orders to be reassigned. The optimization criteria considered can be local in nature in which an individual schedule is considered for choosing the order(s) to be reassigned. In addition, the optimization criteria considered can be applied globally over all the potential schedules of all candidate readers. Furthermore, the optimization criterion may vary from site to site, client to client, or even be system state dependent such as on reader overload conditions.

In one embodiment, the potential costs of missing the due-in-time requirement of given orders due to the removal of the given orders from reader schedule(s) are calculated, and the selection of the order to be reassigned is based on the calculated costs. The quality of a reader schedule can be measured using some criteria, which can be the same criteria as those used to choose between feasible schedules in the method 100 or may be different, as described below. Given orders that improve the quality of the reader schedule, after their removal, above a predefined quality threshold while their costs due to missing their due-in-time requirements fall below a predefined cost threshold can be considered for reassignment. This removal change benefit versus cost tradeoff measurement can also be done during the scan for finding feasible insertion positions for the new order.

It should be understood that various adequate methods or criteria for measuring the quality of a reader schedule can be used. In one embodiment, the reader schedule quality is a function of at least one parameter. Examples of parameters that may be used for measuring the quality of a reader schedule is the total expected reading time, the average expected reading time, the minimum expected reading time, the maximum expected reading time, the variance in expected reading time, the total RVU value, the average RVU value, the minimum RVU value, the maximum RVU value, the variance in RVU value, the total slack value, the average slack value, the minimum slack value, the maximum slack value, the variance in slack value, the minimum due-in-time requirement, the maximum due-in-time requirement, the number of orders contained in the reader schedule, the number of orders having a stat priority, the number of orders to be urgently analyzed, the number of orders having a routine priority, the proportion of stat/routine orders, or the like. In one embodiment, the quality of a reader schedule is desired as low values of the function. So given two reader schedules with different reader schedule quality function values, the reader schedule with the lower function value is considered as of a higher quality than the other schedule with the higher function value. In another embodiment, the quality of a reader schedule is desired as high values of the function. So given two reader schedules with different reader schedule quality function values, the reader schedule with the higher function value is considered as of a higher quality than the other schedule with the lower function value.

In the event that it is past its due-in-time requirement, any order considered for assignment or reassignment can still be assigned to a reader to analyze in some given execution sequence, provided that any incurred penalties are accepted. The approach would be to choose some insertion point for the past due order in an existing reader schedule by applying an optimization criteria. The optimization criteria applied can be the same as that used in method 100. In addition, the optimization criteria can be based on at least one parameter such as SLA penalties, order priority, order RVU, order ERT, order location, or the like. In one embodiment, it is desired to minimize the at least one parameter value to choose the insertion point for the given order. In another embodiment, it is desired to maximize the at least one parameter value to choose the insertion point for the given order. The optimization criteria applicable in this scenario are not limited to the above examples.

The optimization criterion discussed for reassignment policies is not limited to the given examples. In addition, the optimization criterion can vary from site to site or client to client. The method is configurable for different optimization criteria based on site, client, or system state such as when overload conditions are detected for readers. In the case of the latter, a different optimization criterion may be applied over non-overloaded readers versus overloaded readers.

In one embodiment, the distribution engine is adapted to detect orders that may be at risk of missing their due-in-time requirements on a reader's schedule, hereinafter referred to as at-risk orders, based on expected reading times and/or RVU throughput capacity rates of readers. A notification indicative of an at-risk order may be sent to a PACS administrator, an ATC, and/or the reader assigned to the at-risk order for follow up actions, such as promotion of the at-risk order up a reader's schedule or reassignment to another reader with greater reading capacity or having more slack in his or her schedule. The reassignment can be automatically made by the system or manually made by the ATC, the PACS administrator, or any reader with sufficient privileges. The detection of at-risk orders allows monitoring system health and helps with ensuring that orders are read in a timely fashion and following up with actions to mitigate these risks.

A notification may take on any number of forms such as invoking conditional triggers within the PACS, email warnings, warning indicators on graphical user interfaces, dashboard updates, pop-up window warning messages, event logging, beeper alarms, audible alarms, and/or any other sufficient method for notification. The type and form of the notifications are not limited to the above examples. Any appropriate method or form of notification can be used to alert interested parties on at-risk orders.

In one embodiment, the at-risk detection method works given a reader's schedule of assigned orders and their corresponding ERT values and due in time requirements, by computing the slack values of each order. Orders on a reader's schedule with negative slack values are at risk for missing their respective due-in-time requirement. The start time for each order can be approximated by its relative position in the schedule and using the ERT values of all preceding orders in the schedule. The end time for reading an order is approximated as the sum of its start time and its ERT value. Then an order's slack value can be computed by taking the difference between its due-in-time value and its approximate end time. When it is detected, an order having a negative slack is identified as an order being at risk for missing its due-in-time requirement. A notification can then be issued.

In another embodiment, the at-risk detection method may operate with order RVU values and RVU throughput rates of readers instead of ERT values. Given a schedule of orders and corresponding order RVU values, the start and end times for analyzing an order can be approximated using order RVU values and reader RVU throughput rates. The approximate time to read an order can be calculated by dividing the order's RVU value by the reader's RVU throughput rate to give the order's ERT value. Then the at-risk detection method may proceed similarly as described above once the order RVU values are translated to ERT values using the reader's RVU throughput rates.

In a further embodiment, the at-risk detection method can also work without a given reader schedule. In this case, a worklist sequence is created by sorting the assigned orders by ascending due-in-time requirements, so that orders having closer due-in-time requirements are located nearer the top of the created worklist sequence. Then using either the order ERT values or the order RVU values and reader RVU throughput rates, the at-risk detection method can proceed as described above.

In an embodiment in which the schedule for a set of assigned orders is not known or provided, alternative methods besides sorting by due-in-time requirements can be used to generate a worklist sequence to detect the at-risk orders. The alternative methods can include using any optimization criteria to generate a worklist sequence. In particular, the method for generating feasible schedules by insertion of new orders into existing worklist sequences can be applied to the set of assigned orders. The assigned orders can be inserted into a new feasible worklist sequence, which is initially empty, one by one. The insertion sequence for adding the orders can be based on a number of parameters such as order arrival time, order priority, due-in-time value, ERT value, or RVU value. Furthermore, the worklist can be optimized based on some criteria as described above with respect to method 100.

In one embodiment, when at-risk orders are identified, it is possible to quantify the likelihood or probability of the reader missing the orders' due-in-time requirements and provide this additional information in the notifications. The risk level quantification can be based on functions which depend on due-in-time values, ERT values, RVU values, RVU throughput rates, worklist sequences or worklist sets of assigned orders, and/or any other relevant system state information.

For example, the at risk level of a reader for missing a given order's due in time requirement can be quantified as a function of estimated completion time past due in time. The completion time past the due in time requirement can be measured in a gradient scale or classified in ranges such as less than 1 hour (low), between 1 and 2 hours (medium), greater than 2 hours (high) for STAT orders. Another approach to quantify the at risk level is measuring the order RVU value as a proportion to the remaining reader capacity in RVU terms in a gradient scale or classified in ranges such as: less than 10% (low), between 10% and 40% (medium), greater than 40% (high) for STAT orders. In either approaches, different gradient scales or risk level ranges for routine orders may apply since due in time requirements between STAT and routine orders generally differ greatly. In addition, the actual classified range values are not limited to the given thresholds and any reasonable threshold values may be used. It should be understood that the gradient scales and classified ranges for at risk levels can be normalized to a value between 0 and 1, giving a likelihood or probability of the reader missing the given order's due in time requirement. The at risk quantification method is not limited to the given examples. Any function that can be reasonably applied to a reader and a worklist of orders with due in time values, may be used to quantify the risk level of missing due in time requirements.

In one embodiment, changes to the pool of available readers due to shift turnovers, readers logging off, and/or new readers logging on, may affect the overall workload capacity. When a reader signs off a shift the remaining orders on his or her schedule can be sent through the assignment system again for reassignment to other active readers.

When a new reader logs on the system to start analyzing orders, the overall workload capacity increases and rebalancing of already assigned orders from other active readers to the new reader may be desired for better workload balance. In one embodiment, the orders that are pre-selected from existing schedules for reassignment to a new reader can be determined using higher tier rebalancing methods that are not based on due-in-time values. An example of such a rebalancing method involves removing mismatched subspecialty orders from existing reader schedules and assigning to the new reader the given mismatched subspecialty orders that match the subspecialty of the new reader. In another example, the method for rebalancing assigns a number of STAT orders over routine orders to the new radiologist instead.

After a pre-selection pass, further optimization criteria can be applied to select additional orders for rebalancing purposes. The advanced rebalancing can be based on optimization criteria such as the ones used in method 100 for evaluating potential schedules. In the present case, each order in an existing schedule can be considered for removal and the resulting potential schedules from the removal actions are compared using an optimization criterion. The orders to be removed and then reassigned to the new reader are thus determined from the potential schedules, resulting from removal actions, which are ranked or scored highest according to the optimization criteria applied.

The orders selected for reassignment can be inserted into the schedule of the new reader, which is initially empty, using the method 100.

In an embodiment where more than one new reader becomes available, additional optimization criteria, such as those used in the method 100, can be applied to rebalance the selected orders between the new readers. Similarly, the method 100 can be used to insert the selected orders for rebalancing into the schedules of the new readers. In this case, only the new readers are considered as candidate readers for the rebalancing orders and each one of their initial schedule is empty.

It should be understood that at least one optimization criterion for selecting orders for rebalancing can be applied in lieu of the simple pre-selection algorithms. In addition, the optimization criteria for the rebalancing methods can be configurable for different sites, clients, or even be system state dependent such as on reader overload conditions.

Using the above described methods, a reader is assigned a score according to two criteria, the first criterion being the match between the reader subspecialty and the order subspecialty, and the second criterion being the capability of the reader to read a radiology order by its due-in-time requirement. Therefore, each reader is provided with a first score relative to the first criterion, and a second score relative to the second criterion.

In one embodiment, the two scores obtained by each reader are fused together to assign a single preference score to each reader, and the selection of the reader to which a new order will be assigned is made according the single preference score.

In one embodiment, a weight factor is assigned to each criterion according to the relative importance of the criteria. For example, the score obtained for the first and second criteria are each multiplied by their respective weight factor and the weighted scores are added together, thereby obtaining a single score for each reader. The single score may be further normalized so as to be included between 0 and 1 for example. The reader having the highest score is then chosen to read the new radiology order.

In another embodiment, the fusion of the criteria is as follows. Each criterion is used as a partitioning rule such that the most important criterion partitions the readers into ranked subsets, for example, by setting preference score thresholds. Within each of the new partitioned sets of readers, the second criterion is used to further partition the readers therein. The readers who fall within the highest ranked partition subset are considered the best suited for reading the new order.

In one embodiment, the criteria rankings for the partition based fusion method are configurable for different sites and clients depending on their policies. In addition, rankings for the partition based fusion method can change dynamically at run time based on order properties or system state. For example, rankings may change based on mandatory subspecialty matching requirements for certain procedure codes, whereby the subspecialty criterion would have the highest ranking for fusion. Under different procedure codes without mandatory subspecialty matching requirement, workload balance may be preferred in rankings for fusion. In addition, system state such as detection of overloaded subspecialists or detection of overload of all readers at a given location, may change the criteria rankings applicable by the partition based fusion method.

Similarly, the weight factors for the weighted average based fusion method can be configurable for different sites and clients depending on their policies. In addition, the weight factors can change dynamically at run time based on order properties or system state as well. The conditions that apply to ranking changes in the partition based fusion method can also be extended to weight changes in the weighted average based fusion method.

The embodiments of the invention described above are intended to be exemplary only. The scope of the invention is therefore intended to be limited solely by the scope of the appended claims.

I/we claim:

1. A computer-implemented method for selecting readers to analyze a medical image, comprising use of at least one processing unit for:
receiving a radiology order associated with the medical image;
determining an order subspecialty corresponding to the radiology order;
comparing a reader subspecialty of each one of a group of readers to the determined order subspecialty of the radiology order;
identifying given readers amongst the group of readers who are qualified for analyzing the radiology order using the comparison; and
outputting an identification of the given readers.

2. The computer-implemented method of claim 1, wherein said determining an order subspecialty comprises parsing the radiology order using a predefined set of parsing rules.

3. The computer-implemented method of claim 2, wherein at least one of the parsing rules assigns a given subspecialty to a given modality.

4. The computer-implemented method of claim 2, wherein at least one of the parsing rules assigns a given subspecialty to at least one keyword.

5. The computer-implemented method of claim 2, wherein at least one of the parsing rules assigns a given subspecialty to a given period of time.

6. The computer-implemented method of claim 1, wherein said determining an order subspecialty comprises extracting at least one procedure code from the radiology order and retrieving the order subspecialty from a database using the extracted procedure code.

7. The computer-implemented method of claim 1, wherein said determining an order subspecialty comprises determining at least one required subspecialty for the radiology order, and said comparing a reader subspecialty comprises retrieving from a database a qualification subspecialty for each reader and comparing the qualification subspecialty of each reader to the required subspecialty of the radiology order.

8. The computer-implemented method of claim 7, wherein said identifying comprises identifying a given reader as being qualified for the radiology order when the qualification subspecialty of the given reader substantially corresponds to the required subspecialty of the radiology order.

9. The computer-implemented method of claim 1, further comprising use of the at least one processing unit for determining a score for each reader as a function of the comparison, thereby ranking the readers, and said outputting further comprising outputting the score for each reader.

10. The computer-implemented method of claim 7, wherein said determining an order subspecialty further comprises determining a preferred subspecialty for the radiology order, said comparing a reader subspecialty further comprises retrieving from the database a preference subspecialty for each reader and comparing the preference subspecialty of each reader to the required and preferred subspecialties of the radiology order.

11. The computer-implemented method of claim 10, further comprising use of the at least one processing unit for determining a score for each reader as a function of the comparison using weighting factors assigned to the qualification subspecialty and the preference subspecialty, thereby ranking the readers, and said outputting further comprising outputting the score for each reader.

12. The computer-implemented method of claim 1, wherein said determining an order subspecialty comprises determining at least two order subspecialties for the radiology order, the at least two order subspecialties being ranked in a hierarchical configuration.

13. The computer-implemented method of claim 12, wherein said identifying given readers amongst the group of readers comprises identifying at least one given reader as being qualified for the radiology order when the reader subspecialty of the at least one given reader corresponds to a given one of the at least two order subspecialties having the highest rank according to the hierarchical configuration.

14. A computer program product for selecting readers to analyze a medical image, the computer program product comprising a computer readable memory storing computer executable instructions thereon that when executed by a processing unit perform the steps of claim 1.

15. A system for selecting readers as a function of their qualification to read a medical image, the system comprising:
a subspecialty determining unit for receiving a radiology order associated with the medical image and determining a subspecialty corresponding to the radiology order;
a comparison unit for comparing a subspecialty of each one of the readers to the determined subspecialty of the radiology order; and
an identification unit for identifying given readers who are qualified for analyzing the radiology order using the comparison, and outputting an identification of the given readers.

16. The system of claim 15, wherein the subspecialty determining unit is adapted to parse the radiology order using a predefined set of parsing rules.

17. The system of claim 16, wherein at least one of the parsing rules assigns a given subspecialty to a given modality.

18. The system of claim 16, wherein at least one of the parsing rules assigns a given subspecialty to at least one keyword.

19. The system of claim 16, wherein at least one of the parsing rules assigns a given subspecialty to a given period of time.

20. The system of claim 15, wherein the subspecialty determining unit is adapted to extract at least one procedure code from the radiology order and retrieve the order subspecialty from a database using the extracted procedure code.

21. The system of claim 15, wherein the subspecialty determining unit is adapted to determine at least one required subspecialty for the radiology order, and the comparison unit is adapted to retrieve from a database a qualification subspecialty for each reader and compare the qualification subspecialty of each reader to the required subspecialty of the radiology order.

22. The system of claim 21, wherein the identification unit is adapted to identify a given reader as being qualified for the radiology order when the qualification subspecialty of the given reader substantially corresponds to the required subspecialty of the radiology order.

23. The system of claim 15, further comprising a ranking unit for determining a score for each reader as a function of the comparison, thereby ranking the readers, and output the score for each reader.

24. The system of claim 21, wherein the subspecialty determining unit is adapted to determine a preferred subspecialty for the radiology order, and the comparison unit is adapted to retrieve from the database a preference subspecialty for each reader and comparing the preference subspecialty of each reader to the required and preferred subspecialties of the radiology order.

25. The system of claim 15, wherein the subspecialty determining unit is adapted to determine at least two order subspecialties for the radiology order, the at least two order subspecialties being ranked in a hierarchical configuration.

26. The system of claim 25, wherein the identification unit is adapted to identify at least one given reader as being qualified for the radiology order when the reader subspecialty of the at least one given reader corresponds to a given one of the at least two order subspecialties having the highest rank according to the hierarchical configuration.
